(19) United States
(12) Patent Application Publication
(10) Pub. No.: US 2015/0017316 A1
(43) Pub. Date: Jan. 15, 2015

(54) METHOD FOR PRODUCING CARROT PECTIN

(71) Applicant: FUJI OIL COMPANY LIMITED, Izumisano-shi, Osaka (JP)

(72) Inventors: Akihiro Nakamura, Tsukubamirai-shi (JP); Junko Tobe, Tsukubamirai-shi (JP)

(21) Appl. No.: 14/372,654

(22) PCT Filed: Jan. 17, 2013
(86) PCT No.: PCT/JP2013/050806

§ 371 Date: Jul. 16, 2014

(30) Foreign Application Priority Data
Jan. 18, 2012 (JP) 2012-008305

(51) Int. Cl. A23L 1/0524; A23C 9/154

(52) U.S. Cl. CPC A23L 1/0524; A23C 9/1542; A23V 2002/00
USPC 426/654; 426/431

(57) ABSTRACT

Disclosed is a method for producing carrot pectin wherein carrot is extracted with water at a temperature of below 100° C. under conditions with a pH of between 2 and 5, inclusive. The carrot pectin obtained by this production method exhibits excellent dispersion stability for proteins in a wide pH range.

### TECHNICAL FIELD

The present invention relates to a method for producing carrot pectin. The invention further relates to a dispersion stabilizer for an acidic protein food. The invention still further relates to an acidic protein food and to a method for producing the same.

### BACKGROUND ART

Pectin extracted from root vegetables by hot water at 100° C. or higher under acidic conditions is known to function as a stabilizer for an acidic protein food (Patent Literature 1).

### CITATION LIST

### Patent Literature

[Patent Literature 1] Japanese Patent No. 3941772

### SUMMARY OF INVENTION

### Technical Problem

The present inventors have found that when carrot is used as a root vegetable raw material, the carrot pectin extracted by hot water at 100° C. or higher only exhibits adequate dispersion stability for proteins in a narrow pH range of between 4.2 and 4.4, inclusive. Exhibiting dispersion stability for proteins only in a narrow pH range is not desirable since this limits the foods in which the carrot pectin can be used. It is therefore an object of this invention to provide carrot pectin that exhibits excellent dispersion stability for proteins in a wide pH range.

### Solution to Problem

The present inventors have found that carrot pectin extracted with water at a temperature of below 100° C. under prescribed pH conditions exhibits excellent dispersion stability for proteins in a wide pH range, and the invention has been completed upon this finding.

Specifically, the invention relates to a method for producing carrot pectin wherein carrot is extracted with water at a temperature of below 100° C. under conditions with a pH of between 2 and 5, inclusive. The carrot pectin obtained by this production method exhibits excellent dispersion stability for proteins in a wide pH range.

In the above production method, preferably carrot juice residue is used as a raw material. Carrot juice residue is produced in large amounts during the process of industrial scale production of vegetable juice prepared using carrots as a raw material, and it is normally treated as waste. Effective utilization of carrot juice residue may also be expected to provide secondary effects such as lowering production costs for vegetable juice and reducing environmental load.

In the above production method, the temperature of the water used for extraction is preferably between 60° C. and 90° C., inclusive. Extraction under these conditions allows efficient production of carrot pectin.

In the above production method, the extraction is preferably carried out under conditions with a pH of between 2.5 and 4.5, inclusive. By performing extraction under these conditions, it is possible to produce carrot pectin that exhibits excellent dispersion stability for proteins in a wider pH range.

The present invention also relates to a dispersion stabilizer for an acidic protein food comprising carrot pectin obtained by the above production method. The excellent dispersion stability of carrot pectin obtained by the above production method for proteins is utilized.

The dispersion stabilizer can stabilize dispersions of proteins under conditions with a pH of between 4 and 4.6, inclusive. It exhibits dispersion stability for proteins in a wider pH range than dispersion stabilizers obtained by conventional methods.

The invention still further relates to a method for producing an acidic protein food in which the above dispersion stabilizer is added, and to an acidic protein food to which the above dispersion stabilizer has been added.

### Advantageous Effects of Invention

The carrot pectin obtained by the production method of the invention exhibits excellent dispersion stability for proteins in a wide pH range.

### DESCRIPTION OF EMBODIMENTS

Embodiments for carrying out the invention will now be explained in more specific detail, with the understanding that the invention is in no way limited thereby.

### Method for Producing Carrot Pectin

The carrot as a raw material may be the entire carrot root or the juice residue. Juice residue may be frozen or freeze-dried. From the viewpoint of effective utilization of resources, and from the viewpoint of ease of the extraction procedure, it is preferred to use juice residue as a raw material.

The method for producing carrot pectin according to the invention comprises a step in which carrot is extracted with water at a temperature of below 100° C. under conditions with a pH of between 2 and 5, inclusive. By conducting extraction under such conditions, carrot pectin is obtained that exhibits excellent dispersion stability for proteins in a wide pH range. The pH adjustment can be carried out using a mineral acid such as hydrochloric acid, sulfuric acid or phosphoric acid, an organic acid such as citric acid, oxalic acid, tartaric acid or acetic acid, or a hydroxide of an alkali metal or divalent cation, such as sodium hydroxide or calcium hydroxide, or a carbonate or hydrogencarbonate of an alkali metal or a divalent cation. The carrot pectin yield can sometimes be increased by adding a substance with a chelating function, such as hexametaphosphoric acid, phytic acid or EDTA.

The carrot and water are mixed and the pH is adjusted if necessary with an acid or alkali, and then extraction is performed. Alternatively, carrot material and a buffering solution may be mixed and extraction performed. The extraction time will differ depending on the extraction temperature and the like, but it will be usually 30 minutes to 24 hours, inclusive, and is preferably between 1 hour and 3 hours, inclusive. A shorter extraction time will tend to lower the carrot pectin yield, while a longer extraction time will tend to increase production costs.

The extraction temperature is not particularly restricted so long as it is below 100° C., and preferably it is between 60° C. and 90° C., inclusive in consideration of yield and hygiene. A lower extraction temperature will tend to lengthen the extraction time, while a higher extraction temperature will tend to lower the dispersion stability property of the obtained carrot pectin for proteins.

The extraction pH is between 2 and 5, inclusive, and is preferably between 2.5 and 4.5 and more preferably between 2.5 and 4, inclusive. If the extraction pH is too low or too high, the dispersion stability property of the obtained carrot pectin for proteins will tend to be low.

The preferred combination of extraction temperature and pH for obtaining satisfactory dispersion stability properties of the obtained carrot pectin for proteins may be a temperature of between 60° C. and 90° C., inclusive and a pH of between 2.5 and 4.5, inclusive, and a more preferred combination is a temperature of between 60° C. and 90° C., inclusive and a pH of between 2.5 and 4, inclusive. Another preferred combination is a temperature of between 60° C. and 80° C., inclusive and a pH of between 2 and 4.5, inclusive, and another more preferred combination is a temperature of between 60° C. and 80° C., inclusive and a pH of between 2 and 4, inclusive.

There are no particular restrictions on the blending ratio of the carrot and the water or buffering solution, but from the viewpoint of easier processing following extraction and yield, preferably the water or buffering solution is used at 5 to 50 parts by weight with respect to 1 part by weight of carrot material, and more preferably the water or buffering solution is used at 10 to 30 parts by weight with respect to 1 part by weight of carrot material.

Following extraction, the mixture is subjected to solid-liquid separation by a method of centrifugal separation, filter pressing or the like. The insoluble components are separated as solids, and the carrot pectin is contained in the water-soluble fraction.

The separated supernatant can be directly used after drying, but purifying the pectin will increased the utilization value. The method of purification used may be any method for separation and removal of components other than pectins that are present, such as pigment components, proteins, ash components and the like. Specifically, there may be employed any one or a combination of two or more from among active carbon, electrodialysis, an ion exchange resin, hydrophobic resin or UF membrane or a hydrophilic polar solvent such as ethanol or isopropanol. An effective method among these is ethanol precipitation, in which the precipitating property of carrot pectin by addition of ethanol is utilized for purification of carrot pectin. The ethanol precipitation procedure may be carried out once, but preferably it is carried out twice to increase the carrot pectin purity. When the ethanol precipitation procedure is carried out twice, the second ethanol concentration is preferably higher than the first ethanol concentration. More specifically, for example, ethanol is added to the separated supernatant to precipitate carrot pectin. The amount of ethanol added is for a final concentration of 50 to 70 wt % and preferably 60 wt % in the system. The precipitated pectin is subjected to centrifugal separation or allowed to stand for solid-liquid separation. The recovered pectin is rinsed with water-containing ethanol. The water-containing ethanol used for rinsing is preferably water-containing ethanol with 70 to 90 wt % and preferably 80 wt % ethanol. The rinsing is followed by further centrifugal separation or by standing for solid-liquid separation.

Finally, the carrot pectin recovered by the ethanol precipitation is dried.

### Dispersion Stabilizer for an Acidic Protein Food

The dispersion stabilizer for an acidic protein food according to the invention comprises carrot pectin obtained by the method for producing carrot pectin.

An acidic protein food is an acidic food containing animal or vegetable protein, which includes protein foods with acidity, including acidic protein beverages with addition of citrus juices or other juices, or organic acids such as citric acid or lactic acid or inorganic acids such as phosphoric acid, to beverages comprising animal or vegetable proteins, such as milk or soybean milk, and acidic milk beverages obtained by acidifying dairy products, acidic frozen desserts such as acidic ice cream or frozen yogurt containing juices added to milk component-added frozen desserts such as ice cream, acidic desserts obtained by adding juices to gelled foods such as puddings or bavarois, and coffee beverages, lactic acid bacteria beverages (including live and sterilized types), or fermented milk products (solid or liquid). Also, animal or vegetable protein refers to milk, goat milk, nonfat milk or soybean milk, or their powdered products such as whole milk powder, skim milk powder or soybean milk powder, as well as sweetened milk that contains sugar, concentrated milk, and processed milk and fermented milk that have been fortified with minerals such as calcium or vitamins, and proteins derived from the above. Fermented milk refers to fermented milk that has been fermented with addition of a lactic acid bacteria starter after sterilization of animal or vegetable protein, and optionally it may be powdered or have added sugar.

The dispersion stabilizer refers to a substance having a function such that when added to an acidic protein food, allows a uniform dispersion to be obtained without precipitation of the proteins in the foods.

There are no particular restrictions on the amount of addition of a dispersion stability to an acidic protein food, but in order to adequately exhibit dispersion stability properties it is preferably 0.05 to 10 wt % and more preferably 0.2 to 5 wt % as carrot pectin with respect to the final product.

The dispersion stabilizer for an acidic protein food according to the invention can stabilize dispersion of proteins in a wide pH range of between 4 and 4.6, inclusive.

The dispersion stabilizer for an acidic protein food according to the invention may contain, in addition to the carrot pectin, also stabilizers that are known in the prior art, for example, apple- or citrus-derived pectin, water-soluble soybean polysaccharides, carboxymethyl cellulose sodium, propylene glycol alginate ester, carrageenan, microcrystalline cellulose, chitosan, organic acid salts, polymerized phosphoric acid salts, emulsifying agents, heat denatured proteins and the like, which can widen the pH range in which the dispersion stability property for proteins is exhibited.

### Acidic Protein Food and Method for Producing the Same

An acidic protein food of the invention has the above dispersion stabilizer added thereto. Also, a method for producing an acidic protein food according to the invention comprises a step of adding the above dispersion stabilizer. By adding the dispersion stabilizer it is possible to accomplish uniform dispersion of protein in the acidic protein food, thereby providing a satisfactory appearance and flavor and increasing its commercial value.

The definition of an acidic protein food and additive amount of the dispersion stabilizer to the acidic protein food are as described above.

### EXAMPLES

### Example 1

### Extraction of Carrot Pectin with Hot Water at 80° C.

Using freeze-dried carrot juice residue (hereunder also referred to as “carrot pulp”) as a raw material, the carrot pectin was extracted with hot water at 80° C. under conditions with a pH of 2 to 6. First, water was added at 95 parts by weight to 5 parts by weight of freeze-dried carrot pulp, and hydrochloric acid or an aqueous solution of sodium hydroxide was used to adjust the pH to between 2 and 6. After heating at 80° C. for 120 minutes, solid-liquid separation was performed by centrifugal separation (8000 rpm, 30 minutes) to obtain an insoluble component fraction and a water-soluble pectin-containing fraction. Adding ethanol to the pectin-containing fraction at a final concentration of 60 wt % resulted in precipitation of pectin. The precipitated pectin was recovered by centrifugal separation (8000 rpm, 30 minutes). The recovered pectin was rinsed with 80 wt % water-containing ethanol and again subjected to centrifugal separation (8000 rpm, 30 minutes) to recover the pectin. The recovered pectin was air-dried to obtain carrot pectin.

The water-soluble fraction of the carrot pectin was calculated by dividing the dry water-soluble pectin-containing fraction at the time of initial solid-liquid separation, by the dry amount in the slurry before extraction. Also, the dry weight of the finally obtained carrot pectin was divided by the dry weight of the carrot pulp raw material, to calculate the yield. The water-soluble fractions and yields for different conditions are summarized in Table 1. The measured values for the obtained carrot pectin are also summarized in Table 1. The total sugar content was calculated by the phenol-sulfuric acid method, the reducing sugar content was calculated by the Somogyi-Nelson method, the uronic acid content was calculated by the Blumenklantz method and the starch content was calculated by iodine titration. The degree of methyl esterification was calculated by the standard method for pectin (titration). The crude protein was calculated by the Kjeldahl method, and the ash content was calculated by the ashing method.

As clearly seen by the results shown in Table 1, it was confirmed that the extracted carrot pectin was composed mainly of saccharides, with a high galacturonic acid content of 45% or greater, and a high methoxylpectin content, having a methyl esterification degree of 60% or greater.

Also, since the water-soluble fraction was 57% or greater and the yield was 20% or greater, this confirmed that carrot pectin can be extracted at a practical level.

TABLE 1

| Extraction temperature (° C.) | 80 | | | | | | | |
|---|---|---|---|---|---|---|---|---|
| Extraction time (min) | 120 | | | | | | | |
| Extraction pH | 2.0 | 2.5 | 3.0 | 3.5 | 4.0 | 4.5 | 5.0 | 6.0 |
| Water-soluble fraction (%) | 64.4 | 63.0 | 60.1 | 57.9 | 57.8 | 58.6 | 61.1 | 65.0 |
| Yield (%) | 21.6 | 22.5 | 20.5 | 20.8 | 20.9 | 20.5 | 21.0 | 22.0 |
| Total sugars (dry %) | 67.5 | 61.9 | 61.3 | 62.2 | 58.8 | 62.8 | 56.7 | 64.2 |
| Reducing sugars (dry %) | 6.8 | 6.5 | 6.3 | 5.7 | 5.4 | 6.0 | 5.7 | 6.2 |
| Starches (dry %) | 3.8 | 2.3 | 2.3 | 2.8 | 3.1 | 3.1 | 2.4 | 1.9 |
| Uronic acid content (dry %) | 48.8 | 50.8 | 49.4 | 48.0 | 49.1 | 46.1 | 46.9 | 45.1 |
| Esterification degree (%) | 65.0 | 67.9 | 69.0 | 72.1 | 72.1 | 69.4 | 63.2 | 57.4 |
| Crude protein (dry %) | 3.8 | 4.4 | 4.5 | 4.8 | 4.8 | 5.4 | 5.1 | 3.8 |
| Ash content (dry %) | 2.2 | 3.3 | 4.4 | 5.7 | 6.7 | 8.2 | 10.1 | 11.7 |

### Example 2

### Extraction of Carrot Pectin with Hot Water at 60° C.

Carrot pectin was extracted from carrot pulp in the same manner as Example 1. However, the extraction temperature was 60° C. The water-soluble fractions, yields and measured values under different conditions are summarized in Table 2.

TABLE 2

| Extraction | 60 | | | | | | | |
|---|---|---|---|---|---|---|---|---|
| temperature | | | | | | | | |
| (° C.) | | | | | | | | |
| Extraction | 120 | | | | | | | |
| time (min) | | | | | | | | |
| Extraction pH | 2.0 | 2.5 | 3.0 | 3.5 | 4.0 | 4.5 | 5.0 | 6.0 |
| Water-soluble | 61.0 | 60.5 | 58.3 | 55.6 | 55.2 | 56.1 | 56.4 | 53.5 |
| fraction (%) | | | | | | | | |
| Yield (%) | 15.3 | 16.8 | 15.6 | 18.4 | 19.2 | 18.5 | 17.8 | 17.2 |
| Total sugars | 70.2 | 60.2 | 62.7 | 64.2 | 60.5 | 59.2 | 60.6 | 53.4 |
| (dry %) | | | | | | | | |
| Reducing | 7.1 | 6.6 | 5.4 | 5.5 | 4.9 | 6.2 | 5.6 | 4.5 |
| sugars (dry %) | | | | | | | | |
| Starches | 4.5 | 4.4 | 3.5 | 3.0 | 3.2 | 2.6 | 2.9 | 2.5 |
| (dry %) | | | | | | | | |
| Uronic acid | 42.1 | 40.6 | 44.1 | 43.6 | 41.5 | 43.6 | 41.4 | 40.6 |
| content (dry %) | | | | | | | | |
| Esterification | 46.4 | 66.3 | 68.5 | 66.8 | 64.5 | 68.2 | 64.6 | 60.5 |
| degree (%) | | | | | | | | |

### Example 3

### Extraction of Carrot Pectin with Hot Water at 90° C.

Carrot pectin was extracted from carrot pulp in the same manner as Example 1. However, the extraction temperature was 90° C. The water-soluble fractions, yields and measured values under different conditions are summarized in Table 3. With extraction at pH 2.0, the water-soluble fraction exceeded 72% and presumably the hydrolysis of pectin was more than necessary.

TABLE 3

| Extraction temperature (° C.) | 90 | | | | | | | |
|---|---|---|---|---|---|---|---|---|
| Extraction time (min) | 120 | | | | | | | |
| Extraction pH | 2.0 | 2.5 | 3.0 | 3.5 | 4.0 | 4.5 | 5.0 | 6.0 |
| Water-soluble fraction (%) | 73.0 | 70.2 | 68.4 | 69.2 | 66.3 | 69.0 | 64.6 | 67.0 |
| Yield (%) | 25.6 | 26.3 | 24.6 | 26.0 | 25.2 | 29.5 | 27.6 | 25.7 |
| Total sugars (dry %) | 72.2 | 66.8 | 61.7 | 66.1 | 67.6 | 68.3 | 61.9 | 59.8 |
| Reducing sugars (dry %) | 9.2 | 7.1 | 6.7 | 5.5 | 3.8 | 5.1 | 4.2 | 4.0 |
| Starches (dry %) | 4.8 | 2.1 | 1.7 | 1.8 | 1.1 | 0.9 | 1.8 | 0.9 |
| Uronic acid content (dry %) | 41.1 | 47.8 | 45.3 | 50.6 | 49.3 | 47.3 | 45.4 | 48.5 |
| Esterification degree (%) | 66.5 | 67.0 | 67.2 | 66.5 | 65.0 | 66.0 | 63.8 | 59.2 |

### Comparative Example 1

### Extraction of Carrot Pectin by Pressurized Hot Water at 100° C. or Higher

Carrot pectin was extracted from carrot pulp in the same manner as Example 1. However, the extraction temperature was 105° C. or 120° C. The water-soluble fractions, yields and measured values under different conditions are summarized in Table 4.

TABLE 4

| Extraction temperature (° C.) | 105 | | | | | | | 120 |
|---|---|---|---|---|---|---|---|---|
| Extraction time (min) | 120 | | | | | | | 90 |
| Extraction pH | 2.0 | 3.5 | 4.0 | 4.5 | 5.0 | 5.5 | 6.0 | 4.5 |
| Water-soluble fraction (%) | 73.4 | 69.0 | 67.0 | 70.0 | 71.1 | 73.2 | 73.4 | 71.2 |
| Yield (%) | 26.7 | 21.9 | 24.3 | 27.2 | 26.2 | 27.0 | 26.3 | 27.4 |
| Total sugars (dry %) | 53.2 | 65.6 | 66.4 | 66.9 | 67.4 | 66.8 | 64.1 | 62.1 |
| Reducing sugars (dry %) | 7.1 | 6.6 | 7.3 | 6.9 | 7.0 | 6.7 | 5.6 | 7.4 |
| Starches (dry %) | 0.4 | 0.9 | 0.8 | 0.9 | 0.8 | 7.6 | 0.6 | 0.9 |
| Uronic acid content (dry %) | 46.6 | 44.1 | 53.2 | 57.5 | 56.9 | 58.3 | 55.6 | 47.4 |
| Esterification degree (%) | 54.3 | 66.1 | 66.8 | — | — | — | — | 40.8 |

### Test Example 1

### Dispersion Stability of Acidic Milk Beverage

The dispersion stability properties of the carrot pectins obtained in Examples 1 to 3 and Comparative Example 1 for acidic protein foods were evaluated. The pH of an acidic milk beverage (milk-solids-nonfat: 3.0%) was varied in a range of 3.8 to 4.8, and the precipitation rate with addition of 0.2 wt % carrot pectin was examined. The results are summarized in Tables 5 to 8, where a precipitation rate of up to 2% was evaluated as stable (G), a precipitation rate exceeding 2% and no greater than 5% was evaluated as relatively stable (F), and a precipitation rate exceeding 5% was evaluated as not stable (P). As comparative controls there were used water-soluble soybean polysaccharides (SOYAFIBE-S-ZR100, by Fuji Oil Co., Ltd.) and citrus pectin (SM-666 by San-Ei Gen F.F.I., Inc.), which are known to function as dispersion stabilizers for acidic milk beverages.

TABLE 5

| Extraction temperature (° C.) | | | 80 | | | | | | | Water-soluble | |
|---|---|---|---|---|---|---|---|---|---|---|---|
| Extraction time (min) | | | 120 | | | | | | | soybean | Citrus |
| Extraction pH | | 2.0 | 2.5 | 3.0 | 3.5 | 4.0 | 4.5 | 5.0 | 6.0 | polysaccharides | pectin |
| Acidic milk beverage | 3.8 | P | P | P | P | P | P | P | P | G | P |
| pH | 4.0 | G | G | G | G | G | F | P | P | G | F |
| | 4.2 | G | G | G | G | G | G | G | P | G | G |
| | 4.4 | G | G | G | G | G | G | G | P | F | G |
| | 4.6 | G | G | G | G | G | G | G | P | P | F |
| | 4.8 | P | P | P | P | P | P | P | P | P | P |

TABLE 6

| Extraction temperature (° C.) | | 60 | | | | | | | |
|---|---|---|---|---|---|---|---|---|---|
| Extraction time (min) | | 120 | | | | | | | |
| Extraction pH | | 2.0 | 2.5 | 3.0 | 3.5 | 4.0 | 4.5 | 5.0 | 6.0 |
| Acidic milk beverage | 3.8 | P | P | P | P | P | P | P | P |
| pH | 4.0 | G | G | G | G | G | G | F | P |
| | 4.2 | G | G | G | G | G | G | G | P |
| | 4.4 | G | G | G | G | G | G | G | P |
| | 4.6 | G | G | G | G | G | G | G | P |
| | 4.8 | P | P | P | P | P | P | P | P |

TABLE 7

| Extraction temperature (° C.) | | 90 | | | | | | | |
|---|---|---|---|---|---|---|---|---|---|
| Extraction time (min) | | 120 | | | | | | | |
| Extraction pH | | 2.0 | 2.5 | 3.0 | 3.5 | 4.0 | 4.5 | 5.0 | 6.0 |
| Acidic milk beverage | 3.8 | P | P | P | P | P | P | P | P |
| pH | 4.0 | F | G | G | G | G | F | P | P |
| | 4.2 | G | G | G | G | G | G | G | P |
| | 4.4 | G | G | G | G | G | G | G | P |
| | 4.6 | P | G | G | G | G | F | P | P |
| | 4.8 | P | P | P | P | P | P | P | P |

TABLE 8

| Extraction temperature (° C.) | | 105 | | | | | | | 120 |
|---|---|---|---|---|---|---|---|---|---|
| Extraction time (min) | | 120 | | | | | | | 90 |
| Extraction pH | | 2.0 | 3.5 | 4.0 | 4.5 | 5.0 | 5.5 | 6.0 | 4.5 |
| Acidic milk beverage | 3.8 | P | P | P | P | P | P | P | P |
| pH | 4.0 | P | G | P | P | P | P | P | P |
| | 4.2 | P | G | G | P | P | P | P | P |
| | 4.4 | P | G | G | P | P | P | P | P |
| | 4.6 | P | P | P | P | P | P | P | P |
| | 4.8 | P | P | P | P | P | P | P | P |

With carrot pectin, water-soluble soybean polysaccharide and citrus pectin extracted at a temperature exceeding 100° C., sufficient dispersion stabilization was not exhibited for acidic milk beverages at pH 4.6. On the other hand, with carrot pectin extracted under conditions with a temperature of 60° C. or higher and up to 100° C., and a pH of between 2 and 5, inclusive, dispersion stabilization for acidic milk beverages was exhibited in a wide pH range of between 4.2 and 4.6, inclusive. Also, carrot pectin extracted under conditions with a temperature of 60° C. or higher and up to 100° C., and a pH of between 2 and 4 exhibited dispersion stability for acidic milk beverages in a wider pH range of between 4 and 4.6, inclusive.

1. A method for producing carrot pectin wherein carrot is extracted with water at a temperature of below 100° C. under conditions with a pH of between 2 and 5, inclusive.

2. The method according to claim 1, wherein carrot juice residue is used as a raw material.

3. The method according to claim 1, wherein the temperature of the water for extraction is between 60° and 90° C., inclusive.

4. The method according to claim 1, wherein extraction is performed under conditions with a pH of between 2.5 and 4.5, inclusive.

5. A dispersion stabilizer for an acidic protein food, comprising carrot pectin obtained by the method according to claim 1.

6. The dispersion stabilizer according to claim 5, wherein the stabilizer is capable of stabilizing dispersion of proteins under conditions with a pH of between 4 and 4.6, inclusive.

7. A method for producing an acidic protein food, said method comprising adding a dispersion stabilizer according to claim 5.

8. A protein food product comprising an acidic protein food to which a dispersion stabilizer according to claim 5 has been added.

9. A dispersion stabilizer comprising carrot pectin produced by extracting carrot with water at a temperature of below 100° C. under conditions with a pH of between 2 and 5, inclusive.

10. The dispersion stabilizer of claim 9, further comprises an acidic protein food.
